(19) United States
(12) Patent Application Publication
(10) Pub. No.: US 2004/0133331 A1
(43) Pub. Date: Jul. 8, 2004

(54) System and method for automatic holding of a predetermined course on a vehicle

(75) Inventors: Onno Kuttler, Neumunster (DE); Bernd Hames, Henstedt-Ulzburg (DE)

Correspondence Address: ZARLEY LAW FIRM P.L.C., CAPITAL SQUARE, 400 LOCUST, SUITE 200, DES MOINES, IA, 50309-2350, US

(73) Assignee: Sauer-Danfoss (Neumunster) GmbH & Co. OGH, Neumunster (DE)

(21) Appl. No.: 10/704,882

(22) Filed: Nov. 10, 2003

(30) Foreign Application Priority Data
Nov. 11, 2002 (DE) 102 52 311.8

(51) Int. Cl. G06F 7/00

(52) U.S. Cl. 701/82

(57) ABSTRACT

A system for automatically holding a predetermined course in a vehicle with a two-train hydrostatic traction drive, comprising a measurement device (5) for detecting the actual rotational movement of the vehicle around a vertical axis of the vehicle, and for providing a first signal representing the rotational movement. An electronic controller (1) operatively associated with the measurement device (5) to evaluate the first signal to determine the deviation of the first signal from the predetermined course of the vehicle to form a control signal to hydrostatic transmissions of the two-train hydrostatic drive to operate and to provide a course correction.

### BACKGROUND OF THE INVENTION

The invention concerns a system for automatic holding of a predetermined course on a vehicle with a two-train hydrostatic traction drive.

In vehicles with a two-train hydrostatic traction drive, each vehicle side has its own independently controllable hydrostatic transmission, which only drives the wheels or chains of this one vehicle side. Hydrostatic transmissions for the right and left vehicle sides can be adjusted independently of each other in output speed and direction of rotation. Steering movements of the vehicle come about because the wheels or chains of the two vehicle sides acquire different drive speeds. In the extreme case, the two hydrostatic transmissions can be set at opposite directions of rotation and the vehicle rotates in place around its vertical axis.

Separate control of the two hydrostatic transmissions occurs by adjusting the hydrostatic pumps and motors. This can occur by direct adjustment via levers on the tilting wheel. In addition, there is the usual indirect adjustment by mechanical, hydraulic or electrical signals. Finally, electronic control devices are also used, when the pumps and motors of the hydrostatic transmission are electrically adjustable.

Despite all the advantages of separate adjustability of the two traction drives, their synchronization is also of great practical significance. For example, precise straight running of the vehicle should be sought in each case. In addition, the vehicle driver expects that a curved path, once set, is also precisely maintained. Because of unavoidable tolerances, however, even with identical control signals for the two hydrostatic transmissions, different speeds of the wheels or chains often result.

Numerous two-train hydrostatic traction drives are also already known, in which the speeds of the wheels or chains on both vehicle sides are measured and identical output speeds are produced via a controller. However, this solution is still beset with shortcomings. Because of different ground conditions on both vehicle sides and the different slip caused by this, identical advance speeds do not occur in many cases on both sides of the vehicle, despite identical output speeds. Control of the output speeds on both sides of the vehicle with electrohydraulically operated hydrostatic devices is also often burdened with inertia. Because of the delays in the adjustment devices, the driver loses the feeling of direct steering. This can be expressed, for example, in the fact that after adjustment of an exact straight travel, a certain time still elapses until the vehicle actually converts from a deviating course to straight travel. However, the driver expects a feeling of steering as he is accustomed to in simple directly adjusted hydrostatic devices, which, however, can only be imitated with difficulty with servo-adjusted units.

When the pumps of the hydrostatic transmissions can be adjusted electrically, a purely electronic control of the two hydrostatic transmissions can be carried out according to a synchronous run. In order to achieve proper straight travel, a speed sensor is present on the takeoff side of each hydrostatic transmission, which measures the takeoff speed and sends it to an electronic controller as a corresponding signal. The electrically operable hydraulic pumps are then adjusted via a control loop until the vehicle maintains the precise straight course. However, this system has drawbacks too.

Speed sensors of high quality must be incorporated, because they operate in the vehicles primarily at issue here, like construction machines, wheel loaders and the like, in an extremely dirty environment. For this reason, even the wiring of the control device is always threatened, because the hydraulic motors that drive the wheels or chains are often mounted very close to the ground. Consequently, the cables and connectors can easily be damaged or destroyed by dirt, stoning, moisture and striking of obstacles, so that the entire control device fails. In addition, as already mentioned, precise straight travel is in no way guaranteed by the setting of identical wheel or chain speeds on both sides of the vehicle; different ground conditions and the slip caused by this can lead to course deviations, despite the same output speeds. There is also the hazard of a delayed steering behavior that the driver cannot cope with.

It is therefore a principal object of the invention to provide a system of the type just mentioned, with which the course of the vehicle, once chosen, especially straight travel, is precisely maintained even with irregular ground conditions, is operationally reliable and functions largely free of delay.

These and other objects will be apparent to those skilled in the art.

### SUMMARY OF THE INVENTION

This invention serves to solve the foregoing problem. It consists of an arrangement for automatic holding of a predetermined course on a vehicle with a two-train hydrostatic traction drive, with a measurement device, through which the actual rotational movement of the vehicle around the vehicle vertical axis is detected and a signal representing the rotational movement is formed, and with an electronic controller, in which the signal is evaluated as a deviation from the predetermined course and a control signal is formed according to the deviation, through which the hydrostatic transmissions of the two drive trains are operated in the manner of a course correction.

When the rotational movement of the vehicle around its vertical axis is used as reference quantity for the course deviation, the actual rotational movement of the vehicle is detected. The measurement device used for this can be arranged on a protected location within the vehicle and is therefore safely accommodated relative to the effects from the rough work terrain. In addition, by direct transmission of the signal representing the rotational movement to the electronic controller, a largely inertia-free control behavior is produced. The driver of a vehicle equipped with the arrangement according to the invention therefore has the feeling of steering as during driving with a simple, directly adjusted hydrostatic device.

In a first modification, the arrangement according to the invention is geared toward controlling maintenance of a straight course, i.e., exact straight travel. In this case, the electronic controller must be set up so that it returns any rotational movement of the vehicle around its vertical axis back to zero.

According to a further modification, however, it is also possible for the arrangement to control maintaining of a predetermined curve travel. For example, if the driver of the vehicle has adjusted a certain curved travel, additionally occurring rotational movements around the vehicle vertical axis need only be reset, if the adjusted curved travel is to be maintained.

Another specific configuration of the invention provides that the measurement device be designed to detect angular speeds and/or angular accelerations that the vehicle executes with reference to its vertical axis. Devices for detecting angular or rotational speeds, as well as angular and rotational accelerations, are well known. For example, the actual speed over the ground can be measured on the right and left sides of the vehicles with Doppler radar sensors. Measurement devices that are oriented to the earth's magnetic field are also usable. The use of satellite navigation systems, like GPS, for example, is also possible, or acceleration sensors can be used.

According to another configuration of the system, the measurement devices that operate according to the principle of the rotation rate sensor are particularly preferred. The design of the micromechanical rotation rate sensor is particularly preferred. These are gyroscopes for inertial measurement of rotational speeds, also called rotation rates.

When particularly perfect control is supposed to occur and the vehicle equipped with it does not have to operate under unduly severe environmental conditions, according to another configuration, additional sensors for measurement of speeds of the wheels or chains of both vehicle sides are arranged and the corresponding speed signals obtained by this are entered in the electronic controller for additional consideration during formation of the control commands for the drive train.

### BRIEF DESCRIPTION OF THE DRAWINGS

FIG. 1 is a schematic drawing of a circuit for automatic holding of a predetermined course according to the prior art; and

FIG. 2 is a schematic drawing of the circuit of the present invention.

### DESCRIPTION OF THE EMBODIMENTS OF THE INVENTION

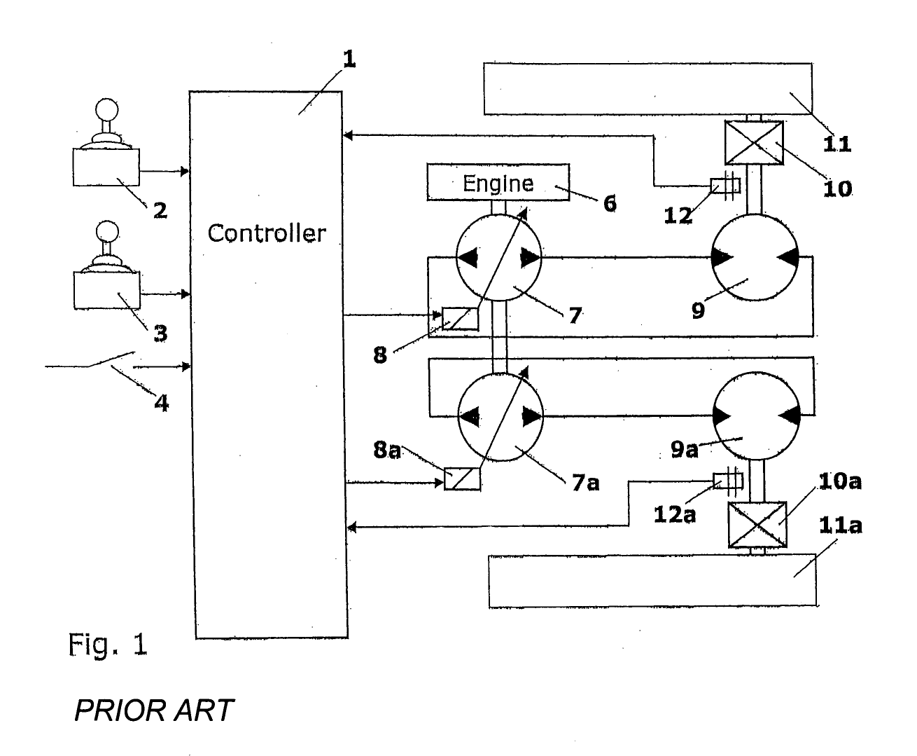

In the arrangement according to the prior art according to FIG. 1, 1 denotes the electronic controller that forms the core of the entire arrangement. This can be acted on by means of control lever 2 for travel signals and control lever 3 for steering signals. A special switch for counter-rotate is denoted 4, in which both drives run opposite each other.

An internal combustion engine 6 drives the two hydraulic pumps 7, 7a of the two drive trains. If the drive train situated on the top in FIG. 1 is initially described, the adjustable hydraulic pump 7 can be adjusted by means of adjustment device 8. It drives a variable stream of hydraulic fluid in a closed loop through the hydraulic motor 9, which is connected to the drive wheel of a chain 11 via a gear mechanism 10. However, a normal driven wheel can just as easily be provided. A sensor that detects the speed of the driven wheel or sprocket and generates a corresponding signal for the electronic controller 1 is denoted 12.

The drive train situated on the bottom of FIG. 1 is constructed identically. The reference numbers are additionally denoted with the symbol “a” for this drive train, as readily follows from the figure.

During operation of the known arrangement, the speeds of the drive wheels are continuously measured, which represent the takeoff with reference to the drive trains. The signals entering the electronic measurement device are compared and, for example, in the case of intended precise straight travel, are changed until they are equal. The known arrangement has the drawbacks already described above.

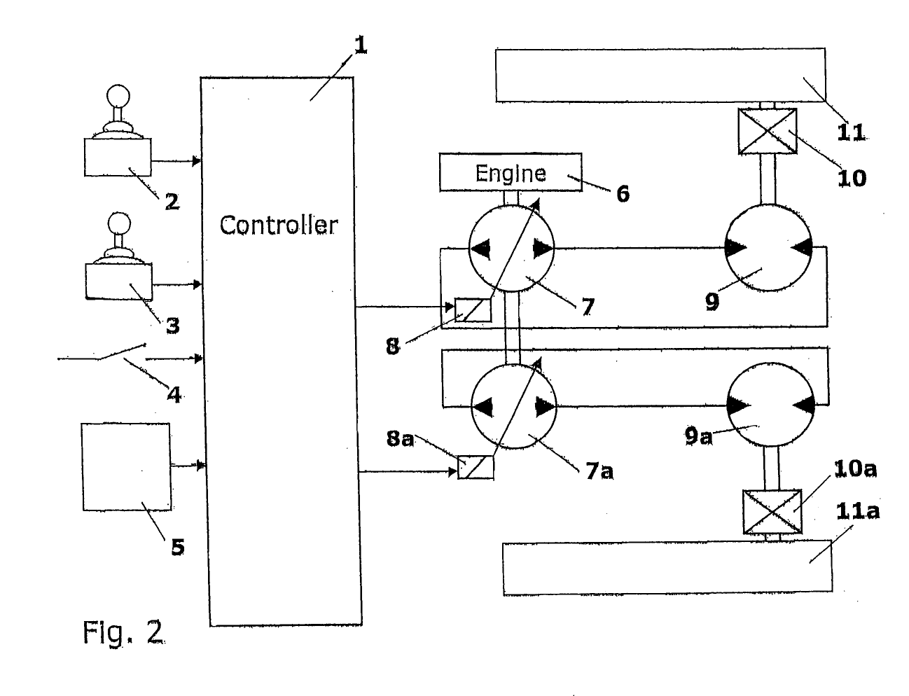

The principle of the arrangement according to the invention is explained in FIG. 2. Essentially the same parts as in FIG. 1 are involved, which then receive the same reference numbers. The sensors 12, 12a for speed measurement are omitted here. The measurement device 5, with which the actual rotational movement of the vehicle around the vehicle vertical axis is detected, is added for this. The measurement device 5 in this case is a micromechanical rotation rate sensor. Each established additional rotational speed that measurement device 5 determines is checked in the electronic controller as to whether it represents a deviation from the course set on the control lever 3. According to the measure of the deviation, a correction signal is then formed and fed to the adjustment devices 8, 8a until the deviation has been returned to zero and the vehicle maintains the intended course.

In summary, the system and method of the invention provides for automatic holding of a predetermined course on a vehicle with a two-train hydrostatic traction drive is proposed. The arrangement includes an electronic controller, which can be acted on by means of a control lever 2 for drive signals and by means of a control lever 3 for steering signals. A switch 4 for counter-rotate is also provided. An internal combustion engine 6 drives the hydrostatic transmissions of the two drive trains. Each of the drive trains includes a hydraulic pump 7, 7a with an adjustment device 8, 8a, a hydraulic motor 9, 9a, as well as a gear mechanism 10, 10a that acts on the drive chain 11, 11a or a wheel of the drive. The measurement device 5 is provided in the form of a micromechanical rotation rate sensor. This detects the actual rotational movements of the vehicle around its vertical axis and sends corresponding signals to the electronic controller 1. The controller compares the signals with the predetermined course and issues corresponding control commands to the adjustment devices 8, 8a of the two drive trains, so that the course is corrected again. The most important application is the one of exact straight travel, in which the two adjustable hydraulic pumps 7, 7a are always corrected, so that the actual rotational movements of the vehicle around the vertical axis reach the value zero.

The arrangement according to the invention is characterized, in particular, by the following advantages:

omission of the costly and vulnerable speed sensor;

incorporation of the rotation rate sensor or measurement device in general at a protected location within the vehicle;

omission of sensitive cabling in the region of the wheels or chains;

detecting of the quantity that actually represents vehicle movement, namely, the rotational movement around the vertical axis;

improvement of straight travel or in general of the adjusted course, regardless of tolerances in the drive system, as well as ground roughness and different slip;

better driving dynamics in agile machines by true measurement of the rotation of the vehicle.

In areas of application in which perfect control matters, the arrangement according to the invention with speed sensors on the drive wheels can also be considered and processing of the obtained signals with the electronic controller. This is not a contradiction of the fundamental objective of the arrangement according to the invention. There are sufficient applications in which vehicles do not have to operate in excessively difficult terrain or a particularly protected, and therefore also costly design of the speed sensors and their cabling can be tolerated.

List of reference numbers

| | |
|---|---|
| 1 | Controller |
| 2 | Control lever for the drive signal |
| 3 | Control lever for the steering signal |
| 4 | Switch |
| 5 | Measurement device |
| 6 | Internal combustion engine |
| 7, 7a | Hydraulic pump |
| 8, 8a | Adjustment device |
| 9, 9a | Hydraulic motor |
| 10, 10a | Gear mechanism |
| 11, 11a | Chain |
| 12, 12a | Sensor |

It is therefore seen that this invention will achieve at least its stated objective.

What is claimed is:

1. A system for automatically holding a predetermined course in a vehicle with a two-train hydrostatic traction drive, comprising;
a measure device (5) for detecting the actual rotational movement of the vehicle around a vertical axis of the vehicle, and for providing a first signal representing the rotational movement, and
an electronic controller (1) operatively associated with the measurement device (5) to evaluate the first signal to determine the deviation of the first signal from the predetermined course of the vehicle to form a control signal to hydrostatic transmissions of the two-train hydrostatic drive to operate and to provide a course correction.

2. The system of claim 1 wherein the measurement device (5) can detect angular speeds and angular accelerations that the vehicle executes with respect to a vertical axis of the vehicle.

3. The system of claim 1 which the measurement device (5) is a rotation rate sensor.

4. The system of claim 1 wherein the measurement device includes a micromechanical rotation rate sensor.

5. The system of claim 1 in which sensors are provided to measure the speeds of wheels on opposite sides of the vehicle and to provide corresponding speed signals to the controller to further influence the course correction.

6. A method for automatically holding a predetermined course in a vehicle with a two-train hydrostatic traction drive, comprising;
providing a measure device (5) for detecting the actual rotational movement of the vehicle around a vertical axis of the vehicle, and for providing a first signal representing the rotational movement, and
providing an electronic controller (1) operatively associated with the measurement device (5) to evaluate the first signal to determine the deviation of the first signal from the predetermined course of the vehicle to form a control signal to hydrostatic transmissions of the two-train hydrostatic drive to operate and to provide a course correction.

7. The method of claim 6 comprising the further step of detecting the angular speeds and angular accelerations that the vehicle executes with respect to a vertical axis of the vehicle.

8. The system of claim 1 in which sensors are provided to measure the speeds of wheels in opposite sides of the vehicle are to provide corresponding speed signals to the controller to further influence the course correction to hold a straight course.

9. The system of claim 1 in which sensors are provided to measure the speeds of wheels in opposite sides of the vehicle are to provide corresponding speed signals to the controller to further influence the course correction to hold a predetermined curved course.
